(19) United States
(12) Patent Application Publication
(10) Pub. No.: US 2024/0051830 A1
(43) Pub. Date: Feb. 15, 2024

(54) TWO-STAGE SYSTEM AND METHOD FOR PRODUCING CARBON NANOTUBES

(71) Applicant: Nanocomp Technologies, Inc., The Woodlands, TX (US)

(72) Inventors: David Gailus, Merrick, NH (US); Deepak VARSHNEY, Merrimack, TX (US); Jonathan PHILLIPS, Los Angeles, CA (US)

(21) Appl. No.: 18/267,121

(22) PCT Filed: Dec. 21, 2021
(86) PCT No.: PCT/US2021/064652

§ 371 Date: Jun. 14, 2023

Related U.S. Application Data
(60) Provisional application No. 63/129,057, filed on Dec. 22, 2020.

(51) Int. Cl. C01B 32/162; B01J 31/22

(52) U.S. Cl. CPC C01B 32/162; B01J 31/2295; C01B 2202/34; C01B 2202/36; C01P 2004/03; B01J 2531/842; B01J 2531/004

(57) ABSTRACT

Two-stage reactor and method for producing carbon nanotubes.

### CROSS REFERENCE TO RELATED APPLICATIONS

This application claims priority to U.S. Provisional Patent Application No. 63/129,057 filed Dec. 22, 2020, the entire contents of which are expressly incorporated herein by reference.

### STATEMENT REGARDING FEDERALLY SPONSORED RESEARCH OR DEVELOPMENT

The invention described herein was made in the performance of work under NASA contract 80LARC18C0007 and is subject to the provisions of section 20135 of the National Aeronautics and Space Act (51 U.S.C. § 20135). The Government may have certain rights in this invention.

### FIELD

The present disclosure generally relates to a two-stage reactor for the production of carbon nanotubes. More specifically, the present disclosure relates to a reactor having a pre-reactor that conditions a catalyst precursor in the presence of a carbon source to form carbon nanotube seeds and a growth reactor that forms carbon nanotubes from the carbon nanotube seeds. A method for the production of carbon nanotubes is also provided.

### BACKGROUND

Typically, carbon nanotubes are formed by directly introducing a mixture of a carbon source, a catalyst precursor, and, optionally, a carrier gas such as nitrogen into a reactor at a temperate sufficient to form long carbon nanotubes (e.g., greater than 1100° C.). Such a process does not allow for much control in the size and dimensions of the resulting nanotubes.

U.S. Pat. No. 9,061,913, which is incorporated by reference in its entirety, allows for better control by using a system having an injector apparatus containing a nebulizer, wherein the injector is partially introduced into the reactor to allow for better control of the temperature of the catalyst precursor as it is introduced into the reactor. The injector apparatus sends the catalyst precursor through the nebulizer and then into two separate pre-heating temperature zones (a first zone at 200° C. to 300° C. and a second zone at 700 to 950° C.) before introducing the catalyst precursor directly into the reactor.

It has now been discovered, as set forth in the present disclosure, that a two-stage reactor also allows for improved control of carbon nanotube formation by having (i) a pre-reactor at a temperature set to optimize the particle size of the catalyst precursor and, thereby, better control the diameter of the resulting carbon nanotubes, and (ii) a growth reactor set at a targeted temperature to better control the length of the resulting carbon nanotubes.

### FIGURES

FIG. 1 is a schematic diagram of a two-stage reactor for the controlled production of carbon nanotubes.

FIGS. 2A and 2B are SEM images of carbon nanotubes.

### DETAILED DESCRIPTION

Before explaining at least one embodiment of the present disclosure in detail, it is to be understood that the present disclosure is not limited in its application to the details of construction and the arrangement of components or steps or methodologies set forth in the following description. The present disclosure is capable of other embodiments or of being practiced or carried out in various ways. Also, it is to be understood that the phraseology and terminology employed herein is for the purpose of description and should not be regarded as limiting.

Unless otherwise defined herein, technical terms used in connection with the present disclosure shall have the meanings that are commonly understood by those having ordinary skill in the art. Further, unless otherwise required by context, singular terms shall include pluralities and plural terms shall include the singular.

All patents, published patent applications, and non-patent publications mentioned in the specification are indicative of the level of skill of those skilled in the art to which the present disclosure pertains. All patents, published patent applications, and non-patent publications referenced in any portion of this application are herein expressly incorporated by reference in their entirety to the same extent as if each individual patent or publication was specifically and individually indicated to be incorporated by reference and to the extent that they do not contradict the instant disclosure.

All of the compositions and/or methods disclosed herein can be made and executed without undue experimentation in light of the present disclosure. While the compositions and methods of the present disclosure have been described in terms of embodiments or preferred embodiments, it will be apparent to those having ordinary skill in the art that variations may be applied to the compositions and/or methods and in the steps or sequences of steps of the methods described herein without departing from the concept, spirit, and scope of the present disclosure. All such similar substitutes and modifications apparent to those skilled in the art are deemed to be within the spirit, scope, and concept of the present disclosure.

Any of the embodiments herein referencing carbon nanotubes may also be modified within the spirit and scope of the disclosure to substitute other tubular nanostructures, including, for example, inorganic or mineral nanotubes. Inorganic or mineral nanotubes include, for example, silicon nanotubes, boron nanotubes, and carbon nanotubes having heteroatom substitution in the nanotube structure.

As utilized in accordance with the present disclosure, the following terms, unless otherwise indicated, shall be understood to have the following meanings.

The use of the word “a” or “an”, when used in conjunction with the term “comprising”, “including”, “having”, or “containing” (or variations of such terms) may mean “one”, but it is also consistent with the meaning of “one or more”, “at least one”, and “one or more than one”.

The use of the term “or” is used to mean “and/or” unless clearly indicated to refer solely to alternatives and only if the alternatives are mutually exclusive.

Throughout this disclosure, the term “about” is used to indicate that a value includes the inherent variation of error for the quantifying device, mechanism, or method, or the inherent variation that exists among the subject(s) to be measured. For example, but not by way of limitation, when the term “about” is used, the designated value to which it refers may vary by plus or minus ten percent, or nine percent, or eight percent, or seven percent, or six percent, or five percent, or four percent, or three percent, or two percent, or one percent, or one or more fractions therebetween.

The use of “at least one” will be understood to include one as well as any quantity more than one, including but not limited to, 1, 2, 3, 4, 5, 10, 15, 20, 30, 40, 50, 100, etc. The term “at least one” may extend up to 100 or 1000 or more depending on the term to which it refers. In addition, the quantities of 100/1000 are not to be considered as limiting since lower or higher limits may also produce satisfactory results.

In addition, the phrase “at least one of X, Y, and Z” will be understood to include X alone, Y alone, and Z alone, as well as any combination of X, Y, and Z. Likewise, the phrase “at least one of X and Y” will be understood to include X alone, Y alone, as well as any combination of X and Y. Additionally, it is to be understood that the phrase “at least one of” can be used with any number of components and have the similar meanings as set forth above.

The use of ordinal number terminology (i.e., “first”, “second”, “third”, “fourth”, etc.) is solely for the purpose of differentiating between two or more items and, unless otherwise stated, is not meant to imply any sequence or order or importance to one item over another or any order of addition.

As used herein, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The phrases “or combinations thereof” and “and combinations thereof” as used herein refers to all permutations and combinations of the listed items preceding the term. For example, “A, B, C, or combinations thereof” is intended to include at least one of: A, B, C, AB, AC, BC, or ABC and, if order is important in a particular context, also BA, CA, CB, CBA, BCA, ACB, BAC, or CAB. Continuing with this example, expressly included are combinations that contain repeats of one or more items or terms such as BB, AAA, CC, AABB, AACC, ABCCCC, CBBAAA, CABBB, and so forth. The skilled artisan will understand that typically there is no limit on the number of items or terms in any combination, unless otherwise apparent from the context. In the same light, the terms “or combinations thereof” and “and combinations thereof” when used with the phrases “selected from” or “selected from the group consisting of” refers to all permutations and combinations of the listed items preceding the phrase.

The phrases “in one embodiment”, “in an embodiment”, “according to one embodiment”, and the like generally mean the particular feature, structure, or characteristic following the phrase is included in at least one embodiment of the present disclosure, and may be included in more than one embodiment of the present disclosure. Importantly, such phrases are non-limiting and do not necessarily refer to the same embodiment but, of course, can refer to one or more preceding and/or succeeding embodiments. For example, in the appended claims, any of the claimed embodiments can be used in any combination.

As used herein, the terms “% by weight”, “wt %”, “weight percentage”, or “percentage by weight” are used interchangeably.

As used herein, “carbon nanotubes” are used to refer to single, double, and/or multiwall carbon nanotubes having a diameter from about 1 nm to about 30 nm and a length of 0.5 mm to 5 mm.

“Carbon nanotube seeds”, as used herein, refers to carbon nanotubes having a length less than about 100 nm and a diameter from about 1 nm to about 30 nm.

“Flare gas”, as used herein, refers to the mixture of gases that are produced during oil and/or gas production or from the operation of refineries, chemical plants, the coal industry, and landfills, and which are commonly burned or flared. The composition of flare gas is dependent on its source, but may comprise one or more of the following carbonaceous gases: methane, ethane, propane, n-butane, isobutane, n-pentane, isopentane, neo-pentane, n-hexane, ethylene, propylene, and 1-butene, as well as one or more other components such as carbon monoxide, carbon dioxide, hydrogen sulfide, hydrogen disulfide, hydrogen, oxygen, nitrogen, and water. It is possible that flare gas from oil-gas production sites mainly contains natural gas comprising more than 90% methane.

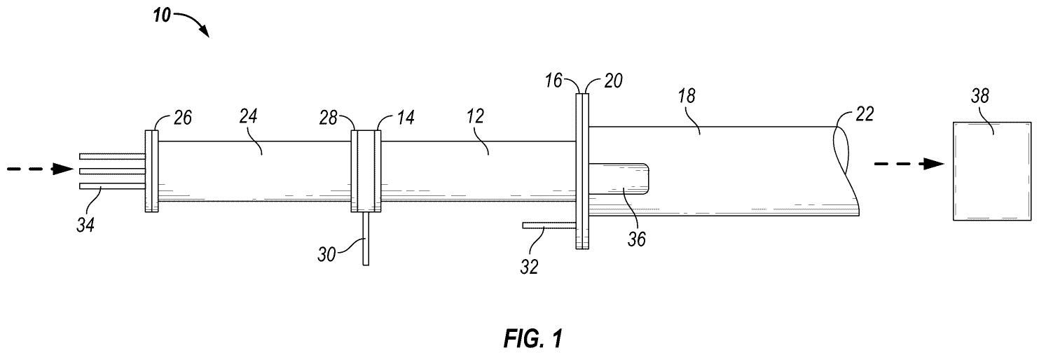

Turning to FIG. 1, the present disclosure, in one aspect, is directed to a two-stage reactor 10 for the controlled production of carbon nanotubes. The two-stage reactor 10 comprises a pre-reactor (also referred to herein as the “first stage”) 12 having a first end 14 and a second end 16 and a growth reactor (also referred to herein as the “second stage”) 18 having a first end 20 and a second end 22, wherein the second end 16 of the pre-reactor 12 is in contact with the first end 20 of the growth reactor 18.

The two-stage reactor 10 can further comprise a flow distributor 24 having a first end 26 and a second end 28, wherein the second end 28 of the flow distributor 24 is in contact with the first end 14 of the pre-reactor 12.

In one embodiment, the two-stage reactor 10 has at least one or more gas injection ports 30 and 32 connected to the pre-reactor 12 or the growth reactor 18 that allow additional reactants or other gaseous components to be introduced into the two-stage reactor 10.

The flow distributor 24 can have one or more passages 34 that allow for the controlled mixture of components, such as, for example, a carbon source and a catalyst precursor, fed into the pre-reactor 12.

In one embodiment, the two-stage reactor 10 contains a separator (not pictured) between the pre-reactor 12 and the growth reactor 18 capable of collecting at least a portion of unwanted materials from entering the growth reactor 18. Non-limiting examples of unwanted materials include unreacted catalyst precursor or particles thereof. In one embodiment, the carbon nanotubes contain less than 10 wt % of the catalyst precursor.

In one embodiment, the separator is selected from a diffusion plate, metal mesh, isolator membrane, a thermal separator, and combinations thereof.

The two-stage reactor can further comprise an injector 36 (i.e., nebulizer) in fluid communication with the second end 16 of the pre-reactor 12 and the first end 20 of the growth reactor 18. The injector 36, in an embodiment, may be designed to receive the components from the pre-reactor 12 and substantially disperse such components to encourage the growth of carbon nanotubes within the growth reactor 18.

The two-stage reactor 10 may also include a collection unit 38 in fluid communication with the second end 22 of the growth reactor 18 for collecting the carbon nanotubes generated in the growth reactor 18.

In another aspect, the present disclosure is directed to a method for producing carbon nanotubes in a two-stage reactor 10, comprising (i) introducing a starting mixture comprising a carbon source and a catalyst precursor into a pre-reactor 12 to produce a conditioned mixture comprising a plurality of carbon nanotube seeds, and (ii) directing the conditioned mixture into the growth reactor 18 to produce carbon nanotubes and hydrogen.

In one embodiment, a supplemental mixture is added to at least one of the pre-reactor 12 and the growth reactor 18. In one particular, embodiment, the supplemental mixture is added directly to the growth reactor 18 via a gas injection port 32.

The pre-reactor 12 is at a temperature in a range of from 400° C. to 900° C. and the pre-conditioned mixture has a residence time in the pre-reactor 12 sufficient to decompose the catalyst precursor to generate catalyst particles and permit a portion of the carbon source to interact with the catalyst precursor to produce a plurality of carbon nanotube seeds.

In one embodiment, the conditioned mixture comprises the plurality of carbon nanotube seeds, a portion of the carbon source, and/or a portion of the catalyst particles. In another embodiment, the conditioned mixture that enters the growth reactor 18 is substantially free of catalyst particles due to (a) substantially all of the catalyst particles interacting with the carbon source to produce the plurality of carbon nanotube seeds and/or (b) substantially all of the catalyst particles being removed by the separator before entering the growth reactor 18.

The growth reactor 18 is at a temperature greater than 1100° C., or more preferably greater than 1200° C., and the residence time of the conditioned mixture in the growth reactor 18 is sufficient to permit the carbon atoms of either (a) the carbon source in the conditioned mixture and/or (b) a supplemental mixture added to the growth reactor 18 to interact with the carbon nanotube seeds to form carbon nanotubes and hydrogen.

The carbon nanotubes have a selectively controlled distribution of diameters and lengths. In one embodiment, a substantial amount (i.e., greater than 70%, greater than 80%, greater than 90%, or greater than 95%) of the carbon nanotubes have a length greater than 1 mm and a diameter in a range of from 3 nm to 15 nm.

The carbon source can comprise carbon monoxide, methane, ethane, propane, butane, hexane, ethylene, propylene, butene, xylene, toluene, benzene, methanol, ethanol, propanol, methyl formate, acetic acid, and mixtures thereof. In one embodiment, the carbon source is treated or untreated flare gas.

The flare gas may be obtained from an oil or gas production site, a refinery, a chemical plant, a coal plant, or landfill. In one embodiment, the system used to produce the carbon nanotubes is onsite at the oil or gas production site, refinery, chemical plant, coal plant, or landfill so that the flare gas can be obtained directly from the source and treated before being introduced into the reactor.

The step of treating the flare gas to form “treated flare gas” comprises subjecting the flare gas to one or more processes to remove excess hydrogen sulfide, hydrogen disulfide, carbon dioxide, and/or carbon monoxide therefrom. As used herein, “excess” is meant an amount sufficient to cause the flare gas to be considered sour gas and have detrimental impact on the ability to produce carbon nanotubes.

Examples of the catalyst precursor from which catalyst particles may be generated includes Ferrocene, FeCl₃, nickelocene, cobaltocene, or other metallocenes, any metal carbonyl, materials such as iron, iron alloy, nickel or cobalt, their oxides, nitrides and/or chlorides of iron, nickel, or cobalt, metal hydroxides, or their alloys (or compounds with other metals or ceramics). Nobel metal particles such as platinum and palladium, or alloys containing these metals, can serve as catalysts as well. Alternatively, the catalyst particles may be made from metal oxides, such as Fe3O4, Fe2O4, or FeO, or similar oxides of cobalt or nickel, or a combination thereof.

In one particular embodiment, the catalyst precursor is selected from ferrocene, iron carbonyl, nickel carbonyl, other metal carbonyls, or a combination thereof.

The starting mixture can further comprise at least one of a carrier gas and an accelerator. In one embodiment, the carrier gas is nitrogen or hydrogen.

The accelerator can be selected from oxygen, carbon monoxide, carbon dioxide, methane, ethane, methanol, ethanol, activated hydrogen, and combinations thereof. In an embodiment, the accelerator is present in the starting mixture in an amount such that there is at least 1:5 ratio of accelerator to carbon source in the growth reactor 18.

The activated hydrogen can be made by passing hydrogen gas (H₂) over a catalyst surface at an elevated temperature (e.g., greater than 500° C. or greater than 600° C.). Non-limiting examples of the catalyst used to make activated hydrogen include palladium, platinum, rhodium, cooper, chromium, and/or oxides of copper, cobalt, iron chromate, and vanadium.

The supplemental mixture can comprise a carbon source, a catalyst precursor, a carrier gas, and/or an accelerator, wherein each, if included, can be the same or different to the carbon source, catalyst precursor, carrier gas, and/or accelerator in the starting mixture.

In one embodiment, hydrogen gas is passed through a catalytic converter furnace to generate activated hydrogen which is then directed into the pre-reactor 12.

The starting mixture and/or supplemental mixture can also contain a conditioner compound including Thiophene, H₂S, other sulfur containing compounds, or a combination thereof.

In one embodiment, the growth reactor 18 is at a temperature ranging from 1100° C. to 1500° C. or in a range of from 1200° C. to 1400° C.

In one particular embodiment, the carbon source in the starting mixture and/or the supplemental mixture comprises ethylene, the accelerator comprises oxygen and the pre-reactor 12 is at a temperature ranging from 550° C. to 700° C.

In another embodiment, the carbon source in the starting mixture and/or the supplemental mixture comprises methane and the pre-reactor 12 is at a temperature ranging from 800° C. to 900° C. or, more preferably, about 850° C.

In yet another embodiment, the carbon source in the starting mixture and/or the supplemental mixture comprises methane, the accelerator is activated hydrogen, and the pre-reactor 12 is at a temperature ranging from 700° C. to 800° C. or, more preferably, about 750° C.

In one embodiment, the residence time of the starting mixture (with or without an amount of the supplemental mixture) in the pre-reactor 12 is less than 20 seconds, or less than 10 seconds, or less than 5 seconds, or less than 4 seconds, or less than 3 seconds, or less than 2 seconds, about 1 second, or less than 1 second. In a preferred embodiment, the residence time of the reactant mixture in the pre-reactor 12 is less than about 10 seconds. In yet another embodiment, the residence time of the reactant mixture in the pre-reactor 12 is about 1 second.

In one embodiment, the pre-reactor 12 is substantially free of carbon nanotubes having (a) a length greater than 100 nm and (b) a diameter greater than 2 nm, or greater than 10 nm, or greater than 20 nm, or greater than 30 nm.

In one particular embodiment, the residence time of the conditioned mixture (with or without an amount of the supplemental mixture) in the growth reactor 18 is in a range from 1 to 100 seconds, or from 1 to 90 seconds, or from 10 to 90 seconds, or from 20 to 80 seconds, or from 20 to 70 seconds, or from 30 to 70 seconds, or from 30 to 60 seconds, or from 40 to 60 seconds. In a preferred embodiment, the residence time of the conditioned mixture (with or without an amount of the supplemental mixture) in the growth reactor 18 is 3 to 20 seconds. A longer residence time in the growth reactor 18 corresponds to an increased length of the carbon nanotubes.

In one embodiment, at least a portion of the carbon nanotubes are collected directly from the growth reactor 18 at, for example, the second end 22 of the growth reactor 18 or, alternatively, by using the collection unit 38 in fluid communication with the second end 22 of the growth reactor 18.

The components of the starting mixture (i.e., the carbon source, the catalyst precursor, the carrier gas, and/or the accelerator) can be introduced individually into the pre-reactor 12 or such components can be mixed prior to being introduced into the pre-reactor 12. Similarly, the components of the supplemental mixture (i.e., the carbon source, the catalyst precursor, the carrier gas, and/or the accelerator) can be introduce individually into the pre-reactor 12 and/or growth reactor 18 or mixed prior to such.

In one embodiment, the carbon source and the catalyst precursor, and optionally, the carrier gas and/or the accelerator, are first introduced into a flow distributor 24 that mixes them into the starting mixture prior to the starting mixture being introduced into the pre-reactor 12.

In one embodiment, the starting mixture enters the pre-reactor 12 at ambient pressure. However, it is envisioned that the starting mixture could enter the pre-reactor 12 at elevated pressures including, for example, 20 psi, or 30 psi, or 50 psi, or 100 psi or greater.

The carbon nanotubes produced by the method disclosed herein can contain less than 10 wt %, or less than 8 wt %, or less than 6 wt %, or less than 5 wt %, or less than 4 wt %, or less than 3 wt %, or less than 2 wt %, or less than 1 wt % iron when the catalyst precursor is ferrocene or iron carbonyl.

The hydrogen formed in the growth reactor 18 can be separated and either collected for storage or resale, used as a fuel to heat the pre-reactor 12 and/or the growth reactor 18, and/or introduced into another reactor

Without intending to be bound to a particular theory, it is thought that one advantage of the two-stage reactor of the present disclosure is that it permits different temperature selection for each stage of the process, allowing for better control of (i) nucleation of small diameter (for example, less than 30 nm, or less than 20 nm, or less than 10 nm, or less than 5 nm, or less than 2 nm) carbon nanotubes, which require an optimum temperature less than 900° C., and (ii) rapid growth of the carbon nanotubes, which requires temperatures in excess of 1100° C. At temperatures greater than 900° C., it is very difficult to impossible to form high concentrations of small diameter carbon nanotubes. The presently disclosed process allows for both the creation of small diameter carbon nanotubes that can be relatively long (i.e., greater than 100 nm or even to a length of 5 mm or more).

### EXAMPLES

A two-stage reactor (as presently claimed) and a single stage reactor with an injector (as taught in U.S. Pat. No. 9,061,913) were used to form carbon nanotubes using methane as the carbon source and ferrocene as the catalyst precursor. The temperatures, pressures, and flow rates for the two-stage reactor and the single stage reactor were approximately the same. In particular, for the two-stage reactor, the methane and ferrocene were introduced with a Sulphur adjuvant into the pre-reactor which was set at 600° C. and then directed to the growth reactor (which was set at 1260° C.) for a residence time of about 4 seconds. For the single stage reactor, the methane, ferrocene, and Sulphur adjuvant were directed directly into the growth reactor (via the injector) for a residence time of about 6 seconds, wherein the growth reactor was also set at 1260° C.

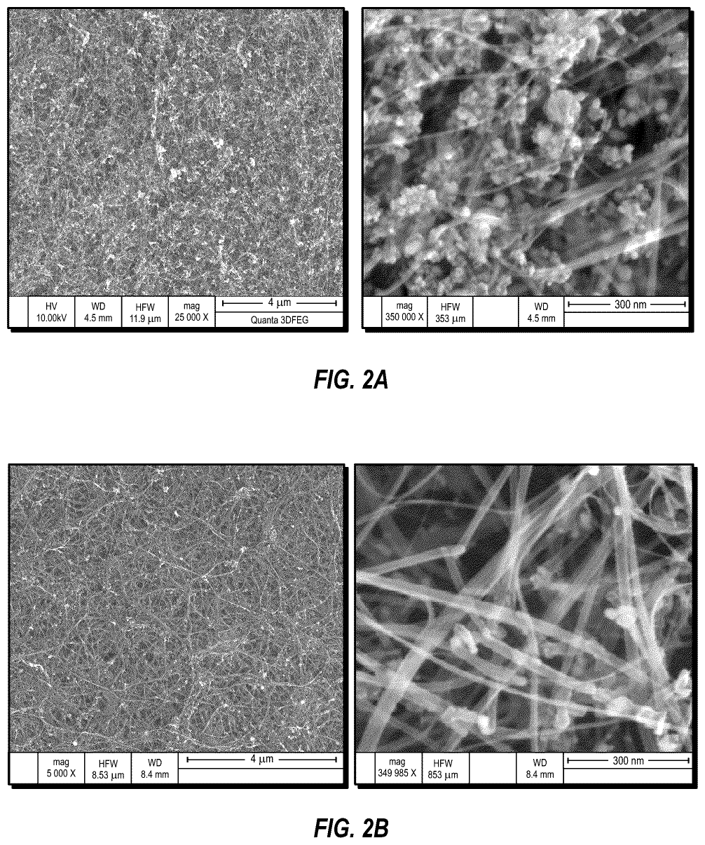

The samples from the different runs were characterized using Scanning Electron Microscopy (SEM), to qualitatively evaluate tube diameter, degree of bundling and amount of amorphous carbon content. FIG. 2A shows a set of images with increasing magnification of a run with reduced input hydrogen and without the use of pre-reactor. A large amount of amorphous carbon is present with non-uniformity in carbon nanotube diameters. Another set of SEM images shown in FIG. 2B suggests that the material produced using the presently disclosed two-stage reactor and method under same process condition comprises less amorphous carbon, higher density of the carbon nanotubes, and the nano tubes are more uniform as compared to the sample grown without the pre-reactor.

Although making and using various embodiments of the present invention have been described in detail above, it should be appreciated that the present invention provides many applicable inventive concepts that can be embodied in a wide variety of specific contexts. The specific embodiments discussed herein are merely illustrative of specific ways to make and use the invention, and do not delimit the scope of the invention.

What is claimed is:

1. A method for producing carbon nanotubes in a two-stage reactor, comprising:
(i) introducing a starting mixture comprising a carbon source and a catalyst precursor into a pre-reactor, wherein the pre-reactor is at a temperature in a range of from 400° C. to 900° C. and the starting mixture has a residence time in the pre-reactor sufficient to decompose the catalyst precursor into catalyst particles and produce a conditioned mixture comprising a plurality of carbon nanotube seeds, and
(ii) directing the conditioned mixture into a growth reactor, wherein the growth reactor is at a temperature greater than 1100° C. and the residence time of the conditioned mixture in the growth reactor is sufficient to produce hydrogen and carbon nanotubes, wherein a substantial amount of the carbon nanotubes have a diameter in a range of 3 to 15 nm and a length greater than 1 mm.

2. The method of claim 1, wherein the carbon source comprises carbon monoxide, methane, ethane, propane, butane, hexane, ethylene, propylene, butene, xylene, toluene, benzene, methanol, ethanol, propanol, methyl formate, acetic acid, or a mixture thereof.

3. The method of claim 1, wherein the catalyst precursor is selected from ferrocene, FeCl₃, a metal carbonyl, a metallocene, an iron alloy, nickel, nickel oxide, cobalt, cobalt oxide, nitrides or chlorides of iron, nickel or cobalt, or a combination thereof.

4. The method of claim 1, wherein the starting mixture further comprises at least one of a carrier gas and an accelerator.

5. The method of claim 4, wherein the accelerator is selected from oxygen, carbon monoxide, carbon dioxide, methane, ethane, methanol, ethanol, activated hydrogen, or a combination thereof.

6. The method of claim 1, wherein a supplemental mixture is added to the growth reactor, wherein the supplemental mixture comprises at least one of a second carbon source and a second catalyst precursor, and wherein the second carbon source comprises carbon monoxide, methane, ethane, propane, butane, hexane, ethylene, propylene, butene, xylene, toluene, benzene, methanol, ethanol, propanol, methyl formate, acetic acid, or a mixture thereof, and the second catalyst precursor is selected from FeCl₃, a metal carbonyl, a metallocene, an iron alloy, nickel, nickel oxide, cobalt, cobalt oxide, nitrides or chlorides of iron, nickel or cobalt, or a combination thereof.

7. The method of claim 6, wherein the supplemental mixture comprises only the second carbon source.

8. The method of claim 6, wherein the second carbon source is different than the carbon source in the starting mixture.

9. The method of claim 6, wherein the supplemental mixture comprises only the second catalyst precursor.

10. The method of claim 6, wherein the second catalyst precursor is different than the catalyst precursor in the starting mixture.

11. The method of claim 1, wherein the residence time of the starting mixture in the pre-reactor is one second or less.

12. The method of claim 1, wherein the residence time of the conditioned mixture in growth reactor is in a range of from 1 second to 100 seconds.
